(19) United States
(12) Patent Application Publication
(10) Pub. No.: US 2014/0178029 A1
(43) Pub. Date: Jun. 26, 2014

(54) Novel Augmented Reality Kiosks

(71) Applicants: Ali Fazal Raheman, Dubai (AE); Fazal Raheman, Dubai (AE)

(72) Inventors: Ali Fazal Raheman, Dubai (AE); Fazal Raheman, Dubai (AE)

(21) Appl. No.: 13/726,660

(22) Filed: Dec. 26, 2012

(51) Int. Cl. H04N 5/77

(52) U.S. Cl. CPC H04N 5/77
USPC 386/224

(57) ABSTRACT

The invention discloses an apparatus and system for establishing an Augmented Reality (AR) Kiosk (ARK) in public places or social venues such as, shopping mall, public transportation terminal, hotel, trade show, conference, convention center, expo, museum, library, college/university campus, amusement park, etc. Categories of ARKs disclosed include, Public and Private ARK, Web and Mobile Ark and their variants. ARK deploys a camera to capture, in real time, user's physical world environment, augments camera view by overlaying one or more layers of contextual computer-generated virtual content, and allows user/users to interact with the virtual content by positioning at a predefined spot in front of a digital display and the camera. Such interaction is recorded in real time, requiring zero post-production time, as composite media file, personalized with recipient's credentials, and instantly sent via Internet to one or more user specified destinations for future use and sharing with friends and family.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD OF INVENTION

The present invention generally relates to the field of augmented reality (AR) systems and apparatus that deploy a camera to capture in real time the physical world environment and then enhance the camera view by adding one or more layers of computer-generated virtual information. Specifically the invention pertains to an AR system that allows a user or the user's prop or pet to enter into an AR environment and become a part of and interact with the virtual information overlay. More particularly the invention relates to an AR kiosk wherein a user or group of users from the audience are positioned at a predefined spot in front of the camera to interact with one or more computer generated layers and records and sends via Internet an AR video of such interaction to one or more user specified destinations for future use and sharing with friends and family.

### PRIOR ART

Augmented Reality, abbreviated to AR, is a new type of digitized human-environment that combines real-world visuals and virtual-world images such as computer graphics to enhance user experience. In other words, augmented reality systems combine a real environment with virtual objects, thereby effectively interacting with users in real time. With this technology the field of view of a user is enriched with computer-generated contextual information.

Augmented reality has been widely used in various fields of application such as the entertainment field and the TV broadcast industry. A very common example that no one can miss is the TV weather broadcast where the forecaster appears in front of a weather chart that keeps changing naturally. AR technology allows a person to see or feel a real world integrated with computer-generated virtual world. The “real world” is the environment that a user can see, feel, hear, taste, or smell using the user's own senses, while the “virtual world” is a computer-generated environment stored in a storage medium and presented as an overlay of image, audio, video, or text information. Most ARs require a marker system to associate the virtual world to the real world. But AR content can also be triggered either manually when a live target object is positioned within video camera's field of view, or automatically by means of face or form recognition, or by means of one or more gestures.

Recently Chen et al, in US App Pub No. 20120162256 disclosed a machine-implemented AR method to enable a user to virtually try on a selected garment. In another recent disclosure Hong US Pub No. 20120166578 provided an augmented reality (AR) system for providing a user with a friend recommendation list corresponding to the interest and/or tendency of the user based on AR history information of the location.

In U.S. Pat. No. 8,002,619, Gagner et al disclosed an augmented reality wagering game system. Dunko in U.S. Pat. No. 8,170,222 disclosed a device and method for providing augmented reality enhanced audio. Baronoff in US App Pub No. 20120122570 described an AR system of multiplayer story-based gaming environment. Adhikari et al have disclosed several embodiments pertaining to AR, such as a computer program AR interface for video (US App Pub No. 20120113142), position identification system (US Pub No. 20120113143), an AR system for providing guide information related to the selected features (US App Pub No. 20120113144), a mobile AR system for surveillance and rescue operations (US App Pub No. 20120113145), an AR interface for video tagging and sharing (US App Pub No. 20120113274), an AR system for product identification and promotion (US App Pub No. 20120116920) and an AR system for supplementing and blending data (20120120101).

### BACKGROUND OF THE INVENTION

AR is a new industry that is still evolving. Based on technological variations in implementing AR experience, the following segments of global AR market are appearing to be branching out:
1. Mobile AR—Most Mobile AR applications introduced in recent times claim to be AR Browsers. Prominent examples are Aurasma, Layar, Metaio, Wikitude, so on and so forth.
2. Desktop AR—Most examples of desktop AR are web-based product promo or demo apps that deploy the computer webcam for camera view and mostly Adobe Flash—based browser plugins. Those in this market segment are mostly advertising and multimedia companies that are catering to big corporations on fee-for-service basis. Installable desktop AR applications are there, but not available on commercial scale.
3. Big Screen AR—Big screen AR applications have recently appeared in public places such as malls, railway stations, trade shows, auditoriums, etc. Big Screen AR applications don't have to depend on any particular Operation System or Browser. They can use either browser plugins or especially designed installable applications.

In a co-pending application, these inventors disclosed a novel Mobile AR application. That invention filled the gap by creating mobile AR stakeholders, incentivizing their participation, and bringing them on a single platform. It created AR communities around very tightly knit, centrally controlled contiguous public places or community centers by engaging all the AR stakeholders and commercially rewarding every stakeholder's participation.

However, Non-Mobile AR does not have these dependencies, and as such can reach the masses without having to download any AR App, and without the limitation of App-specific AR content. Moreover, unlike Mobile AR, Mobile-independent AR allows the users themselves to step into the AR scene and physically interact with the computer-generated content within the AR scene itself. These advantages accelerate the penetration of AR technology into the masses. Nevertheless, even the Non-Mobile AR has major shortfalls that make it difficult to create a sustainable product-based business model. It depends on advertising companies creating AR-based advertisements for major advertisers. It's driven by what advertisers create for users, and leaves no room for what users want to create for themselves. For example a user has no option to shoot and save as a memorabilia an exotic video clip that depicts a live out-of-the world experience, such as interacting with a rare exotic animal like big wild cat such as tiger, lion, panther, etc., or an exotic bird like the macaw parrot, falcon, eagle, etc., or an animal species that is already extinct, or a cartoon character, or a science fiction character or object, a fictional terrestrial or extraterrestrial character, or even a past or present celebrity character. All of those special effects are possible either in high budget movies or corporate advertisements. It's certainly beyond the reach or imagination of a common man.

The present invention, therefore, creates a novel Augmented Reality Kiosk wherein any common man, either for a small fee or free (sponsored by a sponsor), can step into an out-of-the-world AR experience with real life-like computer generated content. And, not just become part of an exotic AR experience, but record and save it for sharing with friends and family and for user's own personal souvenir of lasting memories or memorabilia collection.

In short, prior art AR systems lack network as well as client components essential to creating real world kiosks, including mobile or virtual kiosks (browser-based) wherein any user can create his or her own recordable AR video in real time. They further lack means to save such user-created AR video in real time and share it with friends, family or social networks via Internet. Therefore, there is a need to design and develop AR Kiosks that bring enhanced AR experience within reach of a common man irrespective of whether he has a special AR-enabled device or not, and whether there are advertisers or sponsors to create and distribute AR content or not.

### BRIEF SUMMARY OF THE INVENTION

The present invention addresses the foregoing need for a mobile-independent augmented reality method that any consumer with or without a smartphone can avail and create an out-of-the-world special effects video experience, and save and share it with family and friends. The present invention is directed to devices, systems, methods, programs, computer products, computer readable media, and modules for controlling one or more operating parameters of a camera-enabled computer apparatus that not only generates one or more virtual layers of content superimposed over the camera view on the display screen, but saves the complete animation effect to a computer readable medium in a media file format, and sends the media file to a user desired destination. Accordingly, there is a need for a versatile invention as summarized herein in some detail.

It is therefore an object of the present invention to provide an entirely new AR method of interfacing a real world user audience with virtual world computer-generated content, by means of providing public, private, web or mobile kiosks, wherein any individual(s) with or without a smartphone can step into an AR environment and choose a specific computer-generated content to interface, interact with such content and save the experience on the fly in a video or image file format. Such means of creating out-of-the-world special effects experience was, until now, only possible in hi-tech Hollywood movies. This object is achieved by presenting and superimposing in real time one or more layers of computer-generated content over the live captured camera view of a user and displaying the integrated video on a display screen in front of the user. The object is further achieved by providing a means to save the integrated composite video in one or more of the media file formats known to prior art. The object is further achieved by screencasting or sending the composite media file to one or more user specified destination or/and device.

It is therefore an object of the present invention to provide an AR Kiosk where a user can step in, choose his/her choice of computer-generated virtual content to superimpose on user's real time camera view for the required integrated augmented reality effect, record the AR video, and save or send the AR video to a user preferred Internet destination. As a consequence, it is further object of the invention to provide a public augmented reality kiosk (Public ARK), wherein one or more users, as part of a larger audience, in a public place, participate in an archive-able and sharable interactive and immersive AR experience in front of a large sized screen. It is further object of the invention to provide a private augmented reality kiosk (Private ARK) in a public place or venue, wherein one or more users create a private AR experience that can be saved as a media file and shared with friends and family on the fly and in real time. It is also further object of the invention to provide a web augmented reality kiosk (Web ARK) for extending the exotic AR experience to home-based Internet users with any basic Internet-connected webcam-enabled computer. It is still further object of the invention to provide a mobile augmented reality kiosk (Mobile ARK) for adapting the invention to be implemented in a smart handheld communication device.

It is yet another object of the present invention to allow user an exotic experience by creating user's AR video footage with one or more animals or plants declared as endangered or extinct under the Endangered Species Act of 1973. It is yet further object of the present invention to allow user an out-of-the-world experience by creating user's AR video footage with one or more terrestrial or extraterrestrial fictional characters or objects. It is also another object of the instant invention to allow user an awesome AR experience by creating user's AR video footage with one or more past or present popular celebrity human characters of user's choice.

It is also an object of the instant invention to provide a means for visualizing in three-dimensional perspectives and interacting intuitively with rare, extinct or otherwise inaccessible objects, events, artifacts, specimens, architecture, such as historical, cultural, scientific/biological articles showcased in academic institutions, libraries or museums of various types.

It is also further object of the instant invention to provide a new means for advertisers to engage users by making them protagonists of their own AR video footage. It is also yet another object of the invention to create advertisements on the fly.

It is also further object of the instant invention to further enhance the camera view of an augmented reality visual by adding another computer generated backdrop layer to replace user's background by means of deploying live chroma keying techniques using monochromatic green or blue screens. As a consequence it is yet another object of the invention to minimize the kiosk space for implementing such three-layered augmented reality composite by means of deploying a two-tiered chroma screening approach.

It is the eventual object of the invention to create high-end visual effects, which were until now only possible in high-tech movies with select star casts. It is further object of the invention to produce such high-end visual effects media file instantly on-the-fly without any post-production editing and manipulation. It is therefore the final object of the instant invention to make such out-of-world personalized AR visuals, affordable and accessible to a common man and archive-able as a souvenir of lasting memories, and instantly sharable with friends and family.

These advantages in addition to other objects and advantages of the invention will be set forth in the description which follows, and in part will be obvious from the description, or may be learned by the practice of the invention. The objects and advantages of the invention may be realized and obtained by means of the software, algorithms, devices, remote servers and combinations thereof particularly pointed out in the appended claims.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE DRAWINGS

FIG. 1 is an exemplary block diagram illustrating the operating modules of the present invention.

FIG. 2 is an illustrative flow chart depicting the sequence of steps in the present invention.

FIG. 3 is an exemplary diagram illustrating the components of an embodiment of the present invention as the Public Augmented Reality Kiosk (Public ARK).

FIG. 4 is an exemplary diagram illustrating the components of an embodiment of the present invention as the Private Augmented Reality Kiosk (Private ARK).

FIG. 5 is an exemplary diagram illustrating the components of an embodiment of the present invention as the Web Augmented Reality Kiosk (Web ARK).

FIG. 6 illustrates exemplary network architecture of an Augmented Reality Kiosk (ARK).

FIG. 7 is an exemplary diagram illustrating the aerial view of components of an embodiment of the present invention that incorporate two-tiered real time chroma keying technique.

FIG. 8 is an exemplary diagram illustrating the side view of components of an embodiment of the present invention that incorporate two-tiered real time chroma keying technique.

### DETAILED DESCRIPTION OF THE INVENTION

It is advantageous to define several terms, phrases and acronyms before describing the invention. It should be appreciated that the following terms are used throughout this application. Where the definition of terms departs from the commonly used meaning of the term, applicant intends to utilize the definitions provided below, unless specifically indicated. For the purpose of describing the instant invention following definitions of the technical terms are stipulated:
1. Kiosk—Merriam Webster dictionary defines kiosk as a small structure with one or more open sides that is used to vend merchandise or services. However, within the meaning of this invention a kiosk includes any physical place wherein one or more individuals can interact and participate in a computer-enabled augmented reality experience in front of a digital screen, whether the digital screen is in the private personal space in the privacy of a personal living space such as a home, residence, room; or whether it is in a private enclosure in a public space in shopping mall, public transportation terminal, hotel, trade show, conference, convention center, museum, etc.; or whether it is a digital screen or a digital AR wall, an AR television set, in an open to all (or restricted) public space in shopping mall, public transportation terminal, hotel, trade show, conference, convention center, museum, so on and so forth.
2. ARK—Augmented Reality Kiosk (Public ARK, Private ARK and Web ARK)
3. Public Place—A public space within the meaning of this invention is a social venue or a community center that includes but not limited to shopping mall, public transportation terminal, hotel, trade show, conference, convention center, museum, library, college/university campus, amusement park, social event venue, so on and so forth.
4. Real time image capturing module (RTICM), which is a video camera stationed in a fixed position in front of one or more target objects or human subjects or pets.
5. Real time image display module (RTIDM), which is, either a PDP (plasma display panel), LCD (liquid crystal display), LED (light emitting diode) or OLED (organic light emitting diode) display panel, or a video projector screen, placed in front of the subject(s) preferably in the same vertical plane as the RTICM and capable of displaying high definition video.
6. Augmented Reality Content Module (ARCM), which is a database of computer-generated virtual content in audio, video, animation, 3D image, map or text format or combination thereof in reference to user preferences.
7. Augmented Reality Content Overlay Module (ARCOM), which associates the view captured by the RTICM with specific user preferred content in ARCM database and retrieves the content to display as an overlay that superimposes on the real time view captured by RTICM.
8. Real Time Chroma Keying Module (RTCKM), which comprises of one or more monochromatic chroma key screens whether of green or blue color, deployed to replace the background of the live objects or subjects within the camera's field of view, with a second layer of computer-generated content retrieved from a storage medium in real time serving as altered background of the AR video. Thus RTCKM enables real time production of a multi-layered augmented reality composite video comprising of foreground computer computer-generated virtual content overlay, live camera view layer, and the backdrop computer-generated virtual content overlay, which is created, recorded, personalized, saved locally and delivered to a remote location instantly without any post-production manipulation of the multi-layered composite video.
9. Augmented Reality Video Recording Module (ARVRM), which records on a computer-readable storage medium in real time, the final augmented reality composite scene of the camera view along with the augmented reality overlay audio-video content displayed on the RTIDM as a high definition media (video or image) file in a media format that includes JPG, BMP, PNG, GIF, AVI, FLV, MPEG-4, MP4, SWF, WebM, WMV, MOV, HDMOV, 3GP, MKV, DivX, m4v, f4v, so on and so forth. The ARVRM further personalizes the media file by embedding the name of the user on user's personal copy and names and credentials of user's friends and family on each of the user's shared media file. Thus the ARVRM produces a high definition media file on-the-fly requiring absolutely no post-production editing or manipulation.
10. Communication Module (CM), which instantly delivers the ARVRM recorded video file either to a user defined destination, such as user's communication device, or to user's email account, or to a remote server as a downloadable link, using either wired or wireless telecommunication protocol, or TCP/IP protocol, or WiFi protocol or Bluetooth, or a radiofrequency protocol.
11. Recorded Augmented Reality Content Module (RARCM), which is a database that stores the finally created, recorded, augmented reality media files, personalized with embedded user names and credentials;
12. A central processing unit (CPU), which analyzes and executes the operations of RTICM, RTIDM, ARCM, ARCOM, RTCKM, ARVRM, and CM to complete a user's AR experience.

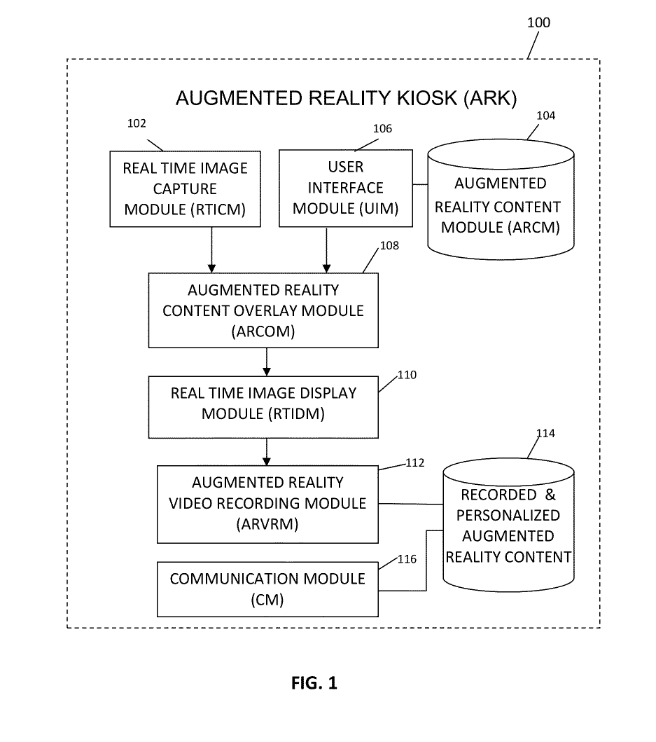

The present invention is now described with reference to the drawings. Referring initially to FIG. 1, the drawing illustrates a system 100 that depicts the operating modules of the ARK. System 100 comprises of RTICM 102, ARCM 104, User Interface Module 106, ARCOM 108, RTIDM 110, ARVRM 112, RARCM 114, CM 116. These modules may be hosted on a local or remote server, CPU. Component 102 provides a means for visualization and capture of real time view of one or more target objects or human subjects or pets, by an image-capturing device such as a video camera. Component 104 provides a means for storage of computer generated virtual content in audio, video, animation, 3D image, map or text format. 104 serves as a repository of preselected computer-generated virtual content comprising of media files featuring a singular or plurality of exotic wild animals or plants, whether endangered or extinct. Such exotic wild animals include but not limited to those belonging to the species such as tiger, lion, panther, leopard, jaguar, bear, koala, deer, gorilla, monkey, snake. It may also include singular or plurality of animals that are extinct or in danger of extinction as classified in Endangered Species Act of 1973. Extinct animals include various species of dinosaurs. The computer-generated content may also include extra-terrestrial fictional characters or objects, a singular or plurality of human celebrities from past or present, a singular or plurality of commercial products or services, or a combination thereof.

The computer-generated content may also include a singular or plurality of exotic birds belonging to the species that include but not limited to eagle, falcon, peacock, seagull, penguin, parrot, so on and so forth. It may also include singular or plurality of cartoon characters, or extraterrestrial alien characters, terrestrial or extraterrestrial vehicles that include popular models of car, motorcycle, or UFO (Unidentified Flying Object). It may also include one or more past or present celebrities. The computer-generated content may also include singular or plurality of body-wearable clothing and accessories, such as headwear, eyewear, makeover items, such as eyelashes, lipsticks, hairbands, hairclips, hairdos, wigs, etc., jewelry items, such as necklace, earrings, nose rings or nose studs, lockets, forehead pendants, etc., bangles and wrist watches, eyewear such as spectacles, sunglasses, contact lenses, makeover items, such as eyelashes, lipsticks, hairbands, hairclips, hairdos, artificial nails, nail polishes, etc. It may also include singular or plurality of advertised products or services.

Component 106 denotes a means for retrieval of virtual content from 104 based on user preference. The virtual computer-generated Augmented Reality (AR) content is triggered and retrieved either manually when a live target object or subject is positioned within video camera's field of view, or automatically by means of placing an AR marker within video camera's field of view, or markerlessly by means of face or form recognition, or by means of one or more gestures, or by means of an infrared remote controller, or by means of a laser pointing device, or by means of wireless radiofrequency signal. Component 108 provides a means for associating the real time object view captured by 102 and superimposes it with an overlay of computer generated virtual content retrieved from 104. Component 110 provides a means for display of the finally combined augmented reality content by a device such as a plasma display panel, an LCD (liquid crystal display) panel, an LED (light emitting diode), an OLED (organic light emitting diode) display panel or a video projector. Component 112 provides a means for recording the finally composited AR video content displayed by 110 on a computer-readable storage medium in real time. Component 114 provides a means for storage of the recorded composite AR video content as a personalized digital media file with user's credentials embedded within the AR video. Component 116 provides a means for transmitting the integrated composite AR video file to one or more user specified destinations such as user's communication device or email account.

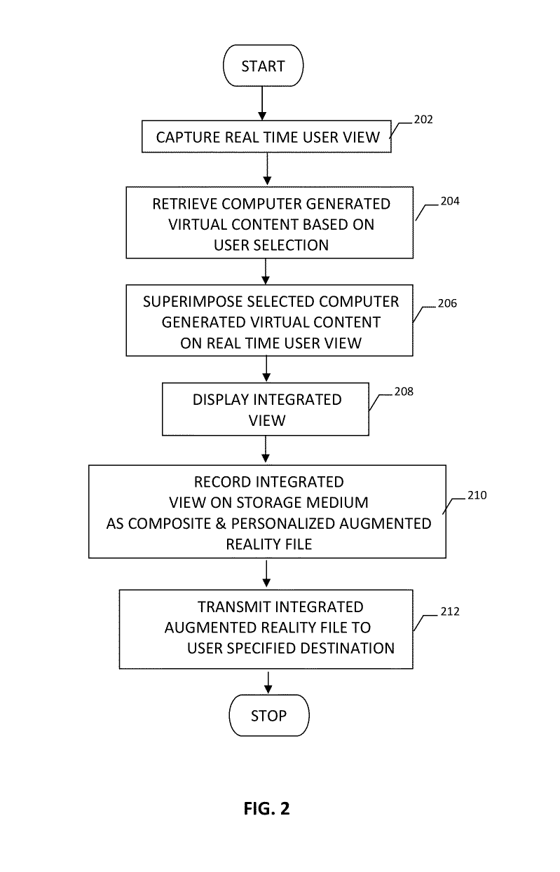

FIG. 2 depicts an exemplar methodology illustrating the steps followed in one aspect of the invention. It is to be understood and appreciated that the present invention is not limited by order of steps and that some of the steps may occur in different order and/or concurrently with other steps from that illustrated here. At step 202, a device such as a video camera captures the real time user or object view. Such camera device is positioned either parallel to or in the same vertical plane as the display screen. At step 204, the preselected virtual content based on user choice is retrieved from a database of computer-generated content. At step 206, the computer-generated content is superimposed on the real time user view based on a manual or automatic trigger. In one embodiment of the present invention, this trigger for such computer-generated content overlay may be automatically activated by means of positioning an AR marker or the target object at a predefined point within view of the video camera. It may also be triggered by automatic face or form recognition. In other embodiments of the present invention, the trigger may be activated manually by the user or the operator, by gestures, by means of wireless signaling devices such as a laser pointer, infra red remote controller or a radio frequency enabled device. At step 208, the integrated superimposed view is displayed in real time on a device such as a plasma display panel, an LCD (liquid crystal display) panel, an LED (light emitting diode), an OLED (organic light emitting diode) display panel or by a video projector. The displayed AR content is captured and recorded in real time at step 210 into a database as a digital media file personalized by embedding the name of the recipient of the composite media file. The composite AR video content file may be stored in one or more of known file formats that include but not limited to JPG, BMP, PNG, GIF, AVI, FLV, MPEG-4, MP4, SWF, WebM, WMV, MOV, HDMOV, 3GP, MKV, DivX, m4v, f4v, so on and so forth. At step 212, the recorded composite AR video content file is instantly transmitted without any post-production delays usually on account of edits or manipulation of prior art, to one or more user specified destinations by user specified means. User defined destinations include, a handheld communication device, an email account, downloadable URL link of a remote server, so on and so forth. In different embodiments of present invention, the recorded composite AR video content file is transmitted through wired or wireless telecommunication protocol, or TCP/IP protocol, or GPRS protocol or WiFi protocol or Bluetooth or radiofrequency protocol or IMAP, SMTP or a telecommunication protocol.

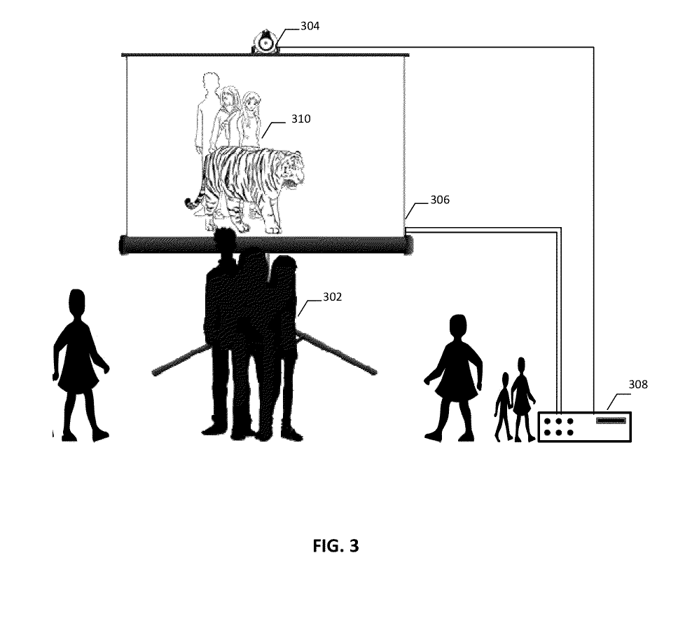

With reference to FIG. 3, which depicts the components of an embodiment of the present invention referred to herein as the Public ARK, 302 represents one or more target users in real time at a public place. 302 may be part of a large audience at a public place. 304 denotes the video camera suitably positioned to capture the real time view of user. In an embodiment of the present invention, 304 is a high definition camera with sensor capability of not less than 1 megapixel sensor. 306 represents a display screen positioned in front of the users. In one embodiment of the invention, the width of 306 is not less than 10 feet and not more than 100 feet, the horizontal field of view of 304 is not less than 80 degrees and not more than 120 degrees, and the distance of 302 from 306 is not less than 20 feet and not more than 50 feet. Preferably, 304 and 306 are positioned in the same vertical plane. 308 represents a means for displaying and recording the superimposed augmented reality content 310.

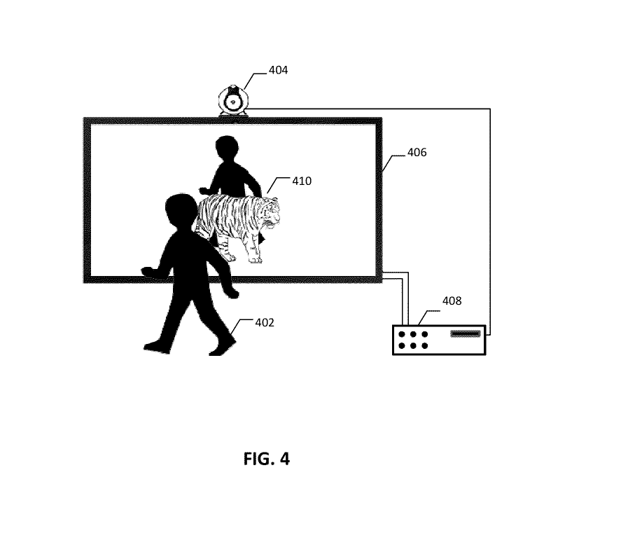

With reference to FIG. 4, which depicts the components of an embodiment of the present invention referred to herein as the Private ARK, 402 represents one or more target users in real time at a private place, such as a kiosk located in a public place. 404 denotes the video camera suitably positioned to capture the real time view of user. In an embodiment of the present invention, 404 is a high definition camera with sensor capability of not less than 1 megapixel sensor. 406 represents a display screen positioned in front of the users. In one embodiment of the invention, the width of 406 is not less than 40 inches and not more than 100 inches, the horizontal field of view of 404 is not less than 80 degrees and not more than 100 degrees, and the distance of 402 from 406 is not less than 6 feet and not more than 18 feet. Preferably, 404 and 406 are positioned in the same vertical plane. 408 represents a means for displaying and recording the superimposed augmented reality content 410.

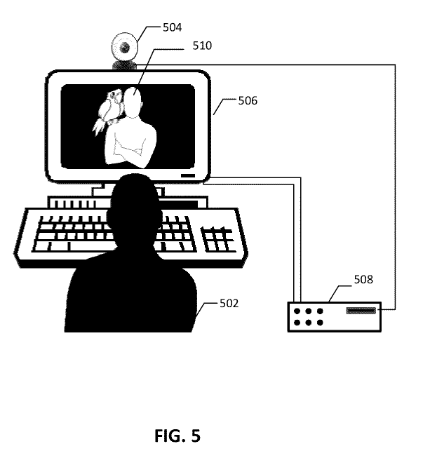

With reference to FIG. 5, which depicts the components of an embodiment of the present invention referred to herein as the Web ARK, 502 represents one or more individual internet users in real time at a private place, such as a webcam enabled computer located in a private place. 504 denotes a webcam suitably positioned to capture the real time view of user. In an embodiment of the present invention, 504 is a high definition camera with sensor capability of not less than 1 megapixel sensor. The sensor is either CCD (Charge Coupled Device) type or CMOS (Complementary Metal Oxide Semiconductor) type. 506 represents a display screen, such as a computer monitor positioned in front of the user. In one embodiment of the invention, the width of 506 is not less than 14 inches and not more than 32 inches, the horizontal field of view of 504 is not less than 40 degrees and not more than 90 degrees, and the distance of 502 from 506 is not less than and not more than 12 feet. Preferably, 504 and 506 are positioned in the same or parallel vertical plane. 508 represents a means for displaying and recording the superimposed augmented reality content 510. Hence, in a preferred embodiment of Web ARK, an AR experience is implemented through an Internet browser of either a desktop computer or a portable computer equipped with a webcam, in which case ARCM database and ARVRM software is hosted on a remote server, and recorded personalized AR media file is saved on the remote server and delivered to the corresponding user either via email, FTP (file transfer protocol) or TCP/IP protocol.

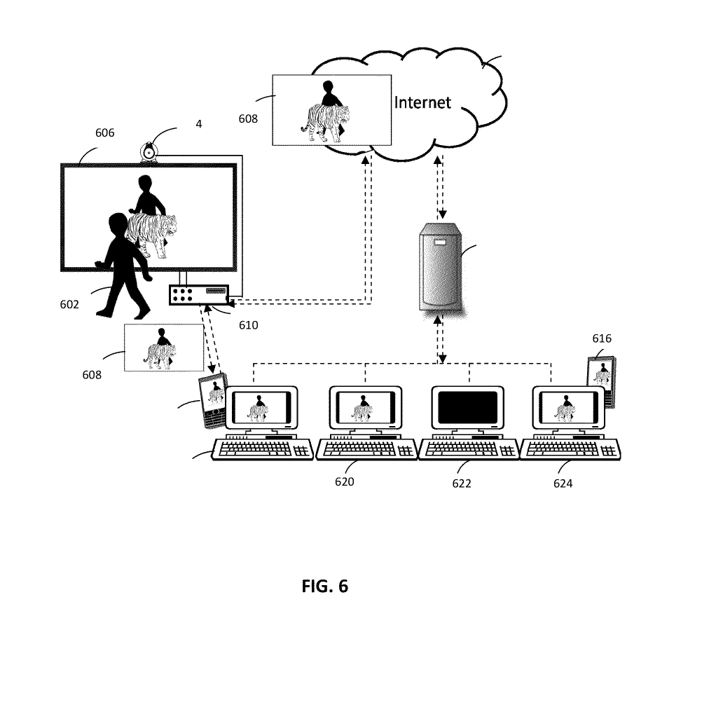

Referring now to FIG. 6, there is illustrated the network architecture for implementing the computing environment in accordance with present invention. For the purpose of illustration, the Private ARK embodiment of the invention is shown here, although it may be appreciated that the same architecture can be implemented for any of the other embodiments of the invention. The real time view of user 602 is captured by 604, displayed on 606 by a processing, integrating and recording means 608 that superimposes augmented reality content 610 on the real time camera view of the user 610a. The recording means 608 records in one or more of the digital media file formats known to prior art and further personalizes such composite medial file by embedding the credentials of the recipient of the media file. Such AR media file 610b may be transmitted by wired and/or wireless communications to one or more user specified destinations that include remote computers or other networked computers or devices connected to the internet for the specific users to download. The remote computer(s) may be a server computer 614, a smart phone device or a hand held computer 616, workstation 618, personal or portable computer 620, a network node 622. In a networked environment the logical connections depicted include wired/wireless connectivity such as GPRS, TCP/IP, Bluetooth, WiFi.

In yet another embodiment a backdrop to the AR video may be further augmented by adding an extra layer of computer-generated content that replaces user's background. Such three-layered AR, that includes an extra background layer, in addition to the foreground and camera view layers, is enabled by using novel live chroma key techniques as disclosed herein. In a conventional method of chroma keying, homogenously colored monochromatic screens of a single color such as green or blue are placed behind the subject to make the subject's background transparent. However, in the instant invention chroma keying is implemented in two-tiered approach as explained in the description that follows.

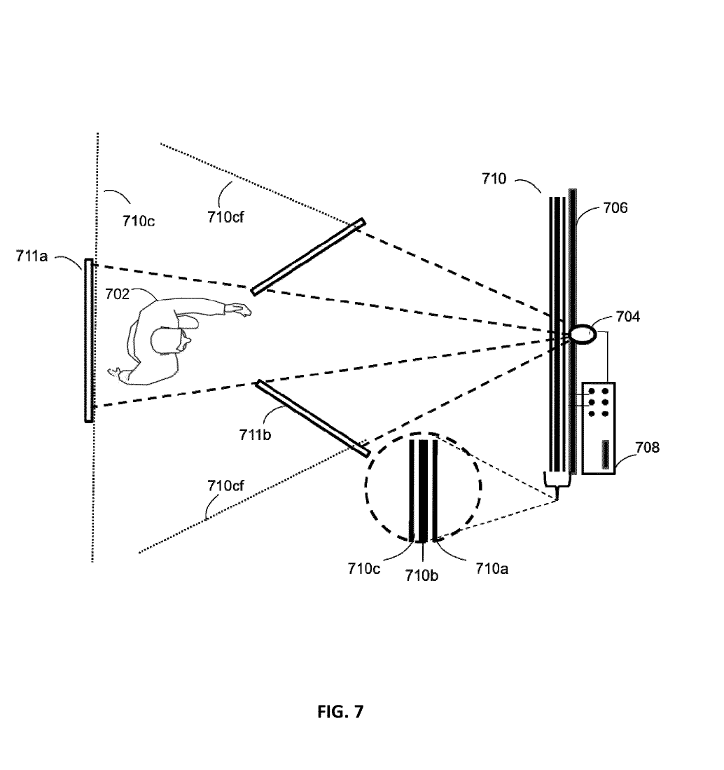

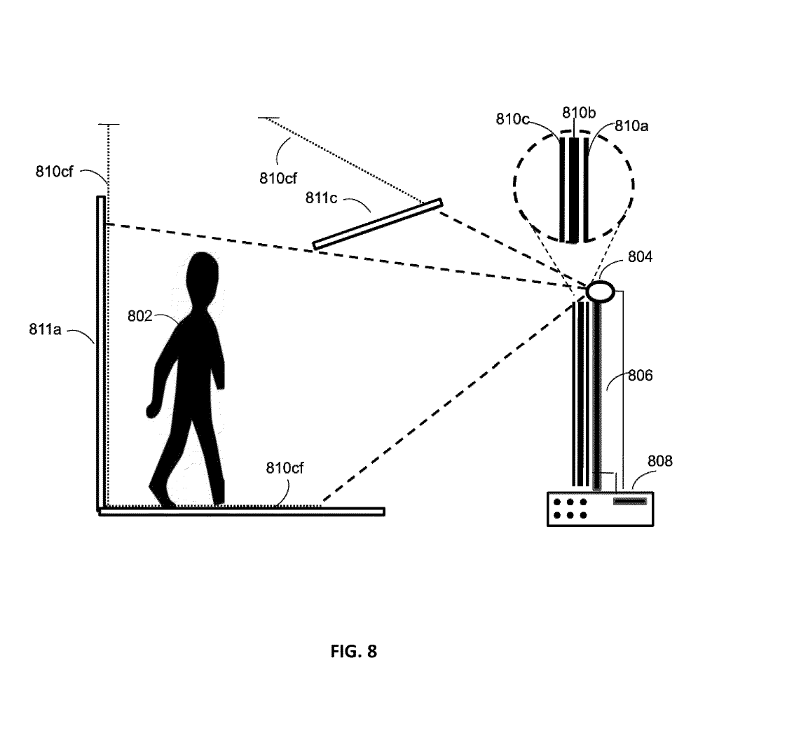

FIGS. 7 and 8 illustrate the deployment of a novel chroma keying technique in real time to make the user's background transparent and replace it with another layer of computer generated content that serves as the user's backdrop. Although any uniform monchromatic color scheme known to prior art may be used, a preferred chroma keying technique may use either green screens or blue screens. This chroma keying embodiment is more relevant to the Private Kiosks described in the preceding paragraphs, wherein it addressed the following problems:
i) The physical background used to create the AR effect may have the limitations of variety, compatibility with the computer-generated AR content and space constraints in a public place;
ii) A camera with wide-angle lens may be more appropriate for creating an AR scene with larger AR objects or characters allowing sufficient mobility within the camera view to create an impactful storyboard for the AR video. However this requires a large area to be covered with chroma keyed backdrop, which is not only very expensive, but bulky enough to be implement in a setting outside of a green screen studio. Thus with the conventional live chroma keying technique it is impossible to create a realistic backdrop.
   These problems in creating an effective three-layered live AR experience are overcome by the chroma key embodiments of the present invention as described herein. With reference to FIG. 7, which depicts the aerial view of the components of an embodiment of the present invention, 702 represents one or more target users or objects or subjects such as humans, props or pets, in real time at an AR kiosk located in a public place. 704 denotes a wide angle video camera suitably positioned to capture the real time view of user. 706 represents a display screen positioned in front of the users. Preferably, 704 and 706 are positioned in the same vertical plane. 708 represents a means for displaying and recording the superimposed AR content 710, wherein the final AR display comprise of the first computer generated content layer 710a, the real time camera view 710b of the subject or object (702), and the second computer generated layer 710c created by the Real Time Chroma Keying Module (RTCKM) and retrieved from a storage medium in real time serving as altered background of the AR video. The RTCKM comprises of chroma screens 711, whether of green or blue color, deployed to replace the background of the live objects or subjects within the camera's field of view, with a second layer of computer-generated content 710c. To minimize the space, a space-saving segregated scheme of sets of chroma screens are positioned in at least two tiers, such as on sides 711b, back 711a and top, synchronized to homogeneously render the entire viewable background within camera's field of view transparent. A chroma key compositing program that runs from the CPU removes color from the chroma screens render them transparent, and replace them in real time with a second layer of computer generated background image or video 710c, thus considerably expanding the field of view 711cf within a limited space.

Likewise, FIG. 8, which depicts the side view of the tiered components of the chroma keying embodiment of the present invention, 802 represents one or more target users/subjects in real time at an AR kiosk located in a public place. 804 denotes a wide angle video camera suitably positioned to capture the real time view of user. 806 represents a display screen positioned in front of the subject or subjects. Preferably, 804 and 806 are positioned in the same vertical plane. 808 represents a means for displaying and recording the superimposed AR content 810, wherein the final AR display comprise of the first computer generated content layer 810a, the real time view 810b of the subject or object (802), and the second computer generated layer 810c created by RTCKM and retrieved from a storage medium in real time serving as altered background of the AR video. The RTCKM comprises of chroma screens 811 laid out in tiers, whether of green or blue color, deployed to replace the background of the live objects or subjects within the camera's field of view, with a second layer of computer-generated content 810c. To minimize the space, a space-saving segregated scheme of sets of chroma screen are positioned in at least two tiers, on sides, back 811a and top 811c, synchronized to homogeneously render the entire viewable background within camera's field of view transparent. A chroma key compositing program that runs from the CPU removes color from the chroma screens render them transparent, and replace them in real time with a second layer of computer generated background image or video 810c, thus considerably expanding the field of view 811cf within a limited space. Thus the multi-layered augmented reality composite video comprising of the foreground computer computer-generated virtual content overlay, the live camera view layer and the backdrop computer-generated virtual content overlay is created, recorded, personalized, saved locally and delivered to a remote location instantly without any post-production manipulation of the multi-layered composite video.

In one further embodiment of the present invention, a handheld communication device, such as a smart mobile phone or a tablet PC can be deployed as a mobile ARK. These smart devices are usually equipped with high-resolution display and video camera on the backside of the display. The back facing camera of such handheld communication devices, which include smartphones and tablet PCs, can be used as RTICM, and the display operates as the RTIDM of the instant invention. The handheld smart communication devices that best suite the implement of the present invention are those that come with high resolution display screen not less than 3 inch and not more than 11 inch in width. The back facing camera integrated within the handheld communication device of the present invention has a horizontal field of view not less than 40 degrees and not more than 90 degrees, and distance of target object from camera is not less than 2 feet and not more than 18 feet.

In another embodiment of the present invention, sponsored promotional or advertising content may be combined with the integrated AR video file and displayed by the RTIDM. In yet another embodiment of present invention, the real time image display module (RTIDM) is capable of supporting more than one display panels, at least one of which is the customer display facing a user who enters the kiosk for the exotic AR experience, and one or more sponsor displays may be used for displaying interactive advertisements produced by sponsor. In yet another embodiment, the sponsor ad display panels may display sponsored content advertising one or more products or services, either as integrated as stand-alone apparatus, or conjoint with private or public augmented reality kiosk

Another embodiment of the present invention provides authorized users to securely access online the recorded augmented reality files from the ARCM database. In yet another embodiment of the present invention, the backdrop of the RTICM provides for an environment attuned to the specific content selected from the ARCM database. Such backdrop may be a jungle scene, snow-laden landscape, sea or river, rural or urban landscape, day or night, so on and so forth depending upon the foreground content layer that augments the real time camera view. Such foreground content that suites a jungle scene may include wild exotic animals or birds like tiger, lion, parrot, falcon. Foreground content that suites a snow landscape may suite an overlay that depicts animals or birds like polar bear or penguin.

In still another embodiment of instant invention, the AR apparatus is architecturally designed and fabricated as an AR Wall or an AR Television set to bring variety of entertaining AR experiences to any human inhabited space, such as a residential space, commercial space, corporate space, or public place such as shopping mall, hotel, conference or tradeshow hall, sports arena, educational institution, library, museum, amusement park, so on and so forth.

In further embodiment of the present invention, the various components of the disclosed AR system are integrated into a television apparatus to create an Augmented Reality Television (ART) set. Such ART sets can be deployed in public or private spaces that include but not limited to shopping malls, conference venues, trade shows, public transport terminals, sports arenas, hotels, corporate offices, educational institutions, and even in residential homes.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

The invention claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An automated computer-enabled augmented reality (AR) apparatus for creating, in real time, a composite AR video comprising, means to visualize and capture a camera view of one or more live target objects or subjects in real time, means to trigger and retrieve computer-generated content from a first storage medium, means to superimpose one or more layers of computer-generated content on the live camera view making such content part of the live camera view, means to display on a display screen such integrated video of camera view and computer-generated content as AR scene, means to record such integrated video as a digital media file, means to personalize such medial file by embedding the name and credential of the recipient of the media file, means to save such composited and personalized media file in second storage medium, and means to transmit such composited and personalized media file to one or more user specified destinations via an Internet connection.

22. An apparatus of claim 21 wherein the apparatus is:
a) a public augmented reality kiosk (ARK) located in an open public space including but not limited to shopping mall, public transportation terminal, hotel, trade show, conference, convention center, expo, museum, library, college/university campus, an amusement park, wherein,
i) display screen's width is not less than 10 feet and not more than 100 feet,
ii) video camera's horizontal field of view is not less than 80 degrees and not more than 160 degrees, and,
iii) distance of target object from display screen is not less than 15 feet and not more than 50 feet.
b) a private ARK situated in a compact structure with one or more open sides that is located in a public place including but not limited to shopping mall, public transportation terminal, hotel, trade show, conference, convention center, expo, museum, library, college/university campus, an amusement park, wherein display screen's width is not less than 40 inches and not more than 100 inches, video camera's horizontal field of view is not less than 60 degrees and not more than 120 degrees, and distance of target object from display screen is not less than 6 feet and not more than 18 feet.
c) a web ARK located in privacy of a personal space, wherein display screen is a personal computer monitor or television screen not less than 14 inch and not more than 60 inch in width, video camera is a webcam with horizontal field of view not less than 40 degrees and not more than 90 degrees, and distance of target object from display screen is not less than 3 feet and not more than 18 feet.
d) a mobile ARK carried by a user as a handheld communication device, wherein display screen is not less than 3 inch and not more than 11 inch in width, video camera is a back facing camera integrated within the handheld communication device that has a horizontal field of view not less than 40 degrees and not more than 90 degrees, and distance of target object from camera is not less than 2 feet and not more than 18 feet.

23. An apparatus of claim 21 wherein the computer-generated content is a photo-real life-like 2D or 3D animation of:
a) one or more animals or plants declared as endangered or extinct under the Endangered Species Act;
b) one or more terrestrial or extraterrestrial fictional characters, cartoons, or objects;
c) one or more past or present popular celebrity human characters;
d) one or more body wearable clothing and accessories that include but not limited to headwear, eyewear such as spectacles, sunglasses, contact lenses, jewelry items, such as necklace, earrings, nose rings, finger rings, or nose studs, lockets, forehead pendants, bangles and wrist watches, makeover items, such as eyelashes, lipsticks, hairbands, hairclips, hairdos, wigs, artificial nails, nail polishes.

24. An apparatus of claim 21, wherein live target object or subject comprise of one or more human subjects, or animal pets, or props, or combination thereof, and wherein the superimposed layer of computer-generated content is triggered either manually when a live target object is positioned within video camera's field of view, or automatically by means of placing an AR marker within video camera's field of view, or by means of face or form recognition, or by means of one or more gestures, or by means of an infrared remote controller, or by means of a laser pointing device, or by means of wireless radiofrequency signal.

25. An apparatus of claim 21, wherein the display screen is a PDP (plasma display panel) LCD (liquid crystal display), LED (light emitting diode) or OLED (organic light emitting diode) display panel or a video projector that projects in real time the composited AR video on a projection screen; and the camera is a high definition video camera with sensor not less than 1 megapixel resolution.

26. An apparatus of claim 21, wherein the multi-layered composite AR media file is recorded in real time without any post-production manipulation, in one or more of known media formats that include but not limited to JPG, BMP, PNG, GIF, AVI, FLV, MPEG-4, MP4, SWF, WebM, WMV, MOV, HDMOV, 3GP, MKV, DivX, m4v, f4v, personalized by embedding name and credential of the composite media file recipient, and delivered in real time to one or more user specified devices or destinations by deploying either TCP/IP protocol, GPRS protocol, WiFi protocol, Bluetooth protocol, POP, IMAP, SMTP or a telecommunication protocol.

27. An apparatus of claim 21, wherein one or more displays comprising of either PDP, LCD, LED, OLED panel or a video projector screen display, integrate, in real time, sponsored content from an advertiser of one or more products or services, with the composite augmented reality video, either as stand-alone apparatus, or conjoint with private or public augmented reality kiosk.

28. An apparatus of claim 21, wherein the augmented reality apparatus is deployed as an augmented reality wall in a human inhabited space that includes a residential space, a commercial space, a corporate space, or a public place such as shopping mall, hotel, conference or tradeshow hall, sports arena, educational institution, library, museum, amusement park, or public transportation terminal.

29. An apparatus of claim 21, wherein a chroma keying module, comprising of one or more monochromatic screens such as green or blue screens, is deployed to replace background of live objects or subjects of AR scene within the camera's field of view, with a backdrop layer of computer-generated content retrieved from a storage medium in real time, serving as altered backdrop of the AR scene.

30. An automated computer-enabled augmented reality kiosk (ARK) system that provides a means to visualize and capture a camera view of one or more live target objects or subjects in real time, superimposed with one or more layers of computer-generated virtual content overlay, making such virtual content part of the camera view in real time as an augmented reality (AR) scene displayed on a display panel comprising of:
a) real time image capturing module (RTICM), which is a video camera stationed in a fixed position in front of one or more target objects;
b) real time image display module (RTIDM), which is either a PDP (plasma display panel), LCD (liquid crystal display), LED (light emitting diode) or OLED (organic light emitting diode) display panel, or a video projector, placed either in a vertical plane identical to the RTICM, or in a vertical plane parallel to the RTICM;
c) Augmented Reality Content Module (ARCM), which is a database of computer-generated content in audio, video, animation, 3D image, map or text format or combination thereof in reference to user preferences;
d) Augmented Reality Content Overlay Module (ARCOM), which associates the view captured by the RTICM with specific user preferred content in ARCM database and retrieves the content to display as an overlay that superimposes on the real time view captured by RTICM;
e) Augmented Reality Video Recording Module (ARVRM), which records as a media file, in real time, on a computer-readable storage medium, the final composite AR scene of the camera view along with the AR overlay of audio-video content, and personalizes such media file by embedding the credentials of a specified media file recipient;
f) Communication Module (CM), which delivers the ARVRM recorded media file instantly either to a user specified device or destination, such as user's communication device or to user's email account or as a downloadable link to a remote server, using either wired or wireless telecommunication protocol, or TCP/IP protocol, or WiFi protocol or Bluetooth, or a radiofrequency protocol;
g) A central processing unit (CPU), which analyzes and executes the operations of RTICM, RTIDM, ARCM, ARCOM, ARVR, CM in real time to complete a user's AR experience.

31. A system of claim 30, wherein the RTICM is a high definition camera with not less than 1 megapixel sensor delivering a video output resolution of not less than 1080×720 pixels per frame, and wherein the apparatus is:
a) a public augmented reality kiosk (ARK) located in an open public space including but not limited to shopping mall, public transportation terminal, hotel, trade show, conference, convention center, expo, museum, library, college/university campus, wherein,
i) display screen's width is not less than 10 feet and not more than 100 feet,
ii) video camera's horizontal field of view is not less than 80 degrees and not more than 160 degrees, and,
iii) distance of target object from display screen is not less than 18 feet and not more than 50 feet;
b) a private ARK situated in a compact structure with one or more open sides that is located in a public place including but not limited to a shopping mall, public transportation terminal, a hotel, a trade show, a conference, a convention center, an expo, a museum, a library, a college or university campus, an amusement park, wherein display screen's width is not less than 40 inches and not more than 100 inches, video camera's horizontal field of view is not less than 60 degrees and not more than 120 degrees, and distance of target object from display screen is not less than 6 feet and not more than 18 feet;
c) a web ARK located in privacy of a personal space, wherein display screen is a personal computer monitor not less than 14 inch and not more than 60 inch in width, video camera is a webcam with horizontal field of view not less than 40 degrees and not more than 90 degrees, and distance of target object from display screen is not less than 3 feet and not more than 18 feet;
d) a mobile ARK carried by a user as a handheld communication device, wherein display screen is not less than 3 inch and not more than 11 inch in width, video camera is a back facing camera integrated within the handheld communication device that has a horizontal field of view not less than 40 degrees and not more than 90 degrees, and distance of target object from camera is not less than 2 feet and not more than 18 feet.

32. A system of claim 30, wherein the user preferred computer-generated overlay content is:
a) one or more exotic wild animals belonging to the species that include but not limited to tiger, lion, panther, leopard, jaguar, bear, koala, deer, gorilla, monkey, snake;
b) one or more exotic birds belonging to the species that include but not limited to eagle, falcon, peacock, seagull, penguin, parrot;
c) one or more animals that are extinct or in danger of extinction;
d) one or more cartoon characters, or extraterrestrial alien characters;
e) one or more past or present celebrities;
f) one or more terrestrial or extraterrestrial vehicles that include popular models of car, motorcycle, or UFO (Unidentified Flying Object);
g) one or more body-wearable clothing and accessories that include but not limited to jewelry items, such as necklace, earrings, finger rings, nose rings or nose studs, lockets, forehead pendants, bangles and wrist watches, eyewear such as spectacles, sunglasses, contact lenses, makeover items, such as eyelashes, lipsticks, hairbands, hairclips, hairdos, wigs, artificial nails, nail polishes;
h) one or more advertised products or services.

33. A system of claim 30, wherein the augmented reality content overlay is activated either;
a) automatically by means of positioning the target object or an AR marker at fixed predefined point within view of the RTICM camera, or markerlessly by means of face or form recognition;
b) manually by a user either by means of gestures, or by means wireless signaling devices like laser pointer, infra red remote controller, RF enabled device or mouse;
c) manually by the operator of the augmented reality kiosk, using wireless signaling devices like laser pointer, infra-red remote controller, RF enabled device, computer keyboard or mouse.

34. A system of claim 30, wherein the wherein the multi-layered composite AR media file is recorded in real time without any post-production manipulation and personalized by the augmented reality video recording module (ARVRM), and delivered to a corresponding user in real time without any post-production manipulation, by the communication module (CM), is in one or more of the known digital media formats that include but not limited to JPG, BMP, PNG, GIF, AVI, FLV, MPEG-4, MP4, SWF, WebM, WMV, MOV, HDMOV, 3GP, MKV, DivX, m4v, f4v.

35. A system of claim 30, wherein an AR experience is implemented through an Internet browser of either a desktop computer or a portable computer equipped with a webcam, in which case ARCM database and ARVRM software is hosted on a remote server, and recorded personalized AR media file is saved on the remote server and delivered to the corresponding user either via email, FTP (file transfer protocol) or TCP/IP protocol.

36. A system of claim 30, wherein the RTICM supports more than one display panels comprising of:
a) a customer display panel that faces a subscribed user of ARK who requests customized AR animation on the customer display panel,
b) one or more advertisement display panel that plays interactive AR advertisement and faces outwards towards general audience.

37. A system of claim 30, wherein the augmented reality apparatus is deployed as an AR wall, or an AR television set, in public or private spaces that include but not limited to shopping malls, conference venues, trade shows, public transport terminals, sports arenas, hotels, corporate offices, educational institutions, museums, libraries and residential homes.

38. An automated computer-enabled augmented reality kiosk (ARK) system that provides a means to visualize and capture a live camera view of one or more target objects or subjects in real time, augmented with a foreground layer of computer-generated virtual content overlay and a backdrop layer of computer-generated virtual content overlay, making the two layers of virtual content part of the camera view in real time, as an augmented reality (AR) scene displayed on a display panel, comprising of:
a) Real time image capturing module (RTICM), which is a video camera stationed in a fixed position in front of one or more target objects;
b) Real time image display module (RTIDM), which is either a PDP (plasma display panel) LCD (liquid crystal display), LED (light emitting diode) or OLED (organic light emitting diode) display panel, or a video projector, placed either parallel to or in a same vertical plane as the RTICM;
c) Augmented Reality Content Module (ARCM), which is a database of computer-generated content in audio, video, animation, 3D image, map or text format or combination thereof in reference to user preferences;
d) Augmented Reality Content Overlay Module (ARCOM), which associates the view captured by the RTICM with specific user preferred content in ARCM database and retrieves the content to display as a first layer that superimposes on the real time view captured by RTICM;
e) Real Time Chroma Keying Module (RTCKM), which comprises of one or more monochromatic chroma screens whether of green or blue color, deployed to replace background of the live objects or subjects within the camera's field of view, with a backdrop layer of computer-generated content retrieved from a storage medium in real time serving as altered background of the AR scene;
f) Augmented Reality Video Recording Module (ARVRM), which records as a media file, in real time, on a computer-readable storage medium, the final composite AR scene of the camera view along with the AR overlays of audio-video content and personalizes such media file by embedding the credentials of the specified media file recipient;
g) Communication Module (CM), which delivers the ARVRM recorded video file to a user specified destination, such as a user's communication device or to user's email account or to a downloadable link to a remote server, using either wired or wireless telecommunication protocol, or TCP/IP protocol, or WiFi protocol or Bluetooth, or a radiofrequency protocol;
h) Central Processing Unit (CPU), which analyzes and executes the operations of RTICM, RTIDM, ARCM, ARCOM, RTCKM, ARVRM, and CM to complete a user's AR experience.

39. A system of claim 38, wherein the RTCKM comprise of:
a) A space-saving segregated scheme of chroma screen sets placed on sides, top and back, synchronized to homogeneously make the entire viewable background within camera's field of view, transparent;
b) A chroma key compositing program that removes color from the chroma screens, renders them transparent, and replaces them with a layer of computer generated background image or video in real time.

40. A system of claim 38, wherein the multi-layered augmented reality composite video comprising of the foreground computer-generated virtual content overlay, the live camera view layer, and the backdrop computer-generated virtual content overlay, is created, recorded, personalized, saved locally and delivered to a user specified remote location instantly without any post-production manipulation of the multi-layered composite video.
